(19) United States
(12) Patent Application Publication
(10) Pub. No.: US 2024/0107480 A1
(43) Pub. Date: Mar. 28, 2024

(54) SIGNALING OF FEEDER LINK AND COMMON DELAY IN A NON-TERRESTRIAL NETWORK

(71) Applicant: FRAUNHOFER-GESELLSCHAFT ZUR FOERDERUNG DER ANGEWANDTEN FORSCHUNG E.V., Muenchen (DE)

(72) Inventors: Arman AHMADZADEH, Erlangen (DE); Thomas HEYN, Erlangen (DE); Elke ROTH-MANDUTZ, Erlangen (DE); Alexander HOFMANN, Erlangen (DE)

(21) Appl. No.: 18/374,880

(22) Filed: Sep. 29, 2023

Related U.S. Application Data
(63) Continuation of application No. PCT/EP2022/058601, filed on Mar. 31, 2022.

(30) Foreign Application Priority Data
Apr. 1, 2021 (EP) 21166692.0

(51) Int. Cl. H04W 56/00

(52) U.S. Cl. CPC H04W 56/009; H04W 56/0015; H04W 56/0045; H04W 84/06

(57) ABSTRACT

Embodiments provide a user equipment configured to communicate with a base station via a satellite, wherein the user equipment is configured to receive, from the base station via the satellite or from another user equipment via a sidelink, a control information, the control information signaling at least one parameter for parameterizing a non-linear function, the parameterized non-linear function describing a course of a round trip time or delay time between the satellite and one out of the base station or satellite gateway, the satellite and a geographical reference point, a first reference point and a second reference point, the first reference point having a fixed relation to the satellite and the second reference point having a fixed relation to one out of the base station, satellite gateway or user equipment, in dependence on a location of the satellite.

### CROSS-REFERENCE TO RELATED APPLICATIONS

This application is a continuation of copending International Application No. PCT/EP2022/058601, filed Mar. 31, 2022, which is incorporated herein by reference in its entirety, and additionally claims priority from European Application No. EP 21166692.0, filed Apr. 1, 2021, which is also incorporated herein by reference in its entirety.

Embodiments of the present application relate to the field of wireless communication, and more specifically, to wireless communication between a base station, gNB, and a user equipment via a satellite/non-terrestrial network, NTN. Some embodiments relate to signaling of feeder link and common delay in NTN.

### BACKGROUND OF THE INVENTION

FIG. 1A and FIG. 1B show schematic representations of an example of a terrestrial wireless network 100 including, as is shown in FIG. 1A, a core network 102 and one or more radio access networks RAN₁, RAN₂, . . . RAN_{N}. FIG. 1B is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The term base station, BS, refers to a gNB in 5G networks, an eNB in UMTS/LTE/LTE-A/ LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1B shows an exemplary view of five cells, however, the RANₙ may include more or less such cells, and RANₙ may also include only one base station. FIG. 1B shows two users UE₁ and UE₂, also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. Further, FIG. 1B shows two IoT devices 110₁ and 110₂ in cell 106₄, which may be stationary or mobile devices. The IoT device 110₁ accesses the wireless communication system via the base station gNB₄ to receive and transmit data as schematically represented by arrow 112₁. The IoT device 110₂ accesses the wireless communication system via the user UE₃ as is schematically represented by arrow 112₂. The respective base station gNB₁ to gNB₅ may be connected to the core network 102, e.g., via the S1 interface, via respective backhaul links 114₁ to 114₅, which are schematically represented in FIG. 1B by the arrows pointing to “core”. The core network 102 may be connected to one or more external networks. Further, some or all of the respective base station gNB₁ to gNB₅ may connected, e.g., via the S1 or X2 interface or the XN interface in NR, with each other via respective backhaul links 116₁ to 116₅, which are schematically represented in FIG. 1B by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix (CP) length. All OFDM symbols may be used for DL or UL or only a subset, e.g., when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g., DFT-s-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIG. 1A and/or FIG. 1B may by a heterogeneous network having distinct overlaid networks, e.g., a network of macro cells with each macro cell including a macro base station, like base station gNB₁ to gNB₅, and a network of small cell base stations (not shown in FIG. 1A and/or FIG. 1B), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1A and/or FIG. 1B, for example in accordance with the LTE-Advanced Pro standard or the NR (5G), new radio, standard.

In mobile communication networks, for example in a network like that described above with reference to FIG. 1A and/or FIG. 1B, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1A and/or FIG. 1B.

This is referred to as an “in-coverage” scenario. Another scenario is referred to as an “out-of-coverage” scenario. It is noted that “out-of-coverage” does not mean that the two UEs are not within one of the cells depicted in FIG. 1A and/or FIG. 1B, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex, TDD, systems.

FIG. 2 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1A and/or FIG. 1B. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 3 is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 206, 208 and 210 are shown directly communicating with each other over a sidelink, e.g., using the PC5 interface. Thescheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3 which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 2, in addition to the NR mode 1 or LTE mode 3 UEs 202, 204 also NR mode 2 or LTE mode 4 UEs 206, 208, 210 are present.

Naturally, it is also possible that the first vehicle 202 is covered by the gNB, i.e. connected with Uu to the gNB, wherein the second vehicle 204 is not covered by the gNB and only connected via the PC5 interface to the first vehicle 202, or that the second vehicle is connected via the PC5 interface to the first vehicle 202 but via Uu to another gNB, as will become clear from the discussion of FIGS. 4 and 5.

FIG. 4 is a schematic representation of a scenario in which two UEs directly communicating with each, wherein only one of the two UEs is connected to a base station. The base station gNB has a coverage area that is schematically represented by the circle 200 which, basically, corresponds to the cell schematically represented in FIG. 1A and/or FIG. 1B. The UEs directly communicating with each other include a first vehicle 202 and a second vehicle 204, wherein only the first vehicle 202 is in the coverage area 200 of the base station gNB. Both vehicles 202, 204 are connected directly with each other over the PC5 interface.

FIG. 5 is a schematic representation of a scenario in which two UEs directly communicating with each, wherein the two UEs are connected to different base stations. The first base station gNBi has a coverage area that is schematically represented by the first circle 200₁, wherein the second station gNB₂ has a coverage area that is schematically represented by the second circle 200₂.

The UEs directly communicating with each other include a first vehicle 202 and a second vehicle 204, wherein the first vehicle 202 is in the coverage area 200₁ of the first base station gNB₁ and connected to the first base station gNB₁ via the Uu interface, wherein the second vehicle 204 is in the coverage area 200₂ of the second base station gNB₂ and connected to the second base station gNB₂ via the Uu interface.

In a wireless communication system as described above, in 3GPP a new working item (WI), introducing Non-Terrestrial Networks (NTN) has been started. Within this WI the technical feasibility of various satellite systems (GEO, MEO, LEO, etc.) and High Altitude Platforms (HAPS) to be part of the network architecture of 3GPP Rel-17 will be studied.

One of the unique features of NTN is the large propagation delays experienced between user terminals (UE) and satellite systems, and as a consequence, the gNB. Typically, the propagation delays in terrestrial systems are less than 1 ms. However, in NTN, the propagation delays can potentially range from several milliseconds to hundreds of milliseconds depending on the altitudes of the spaceborne or airborne platforms and payload type in NTN, as indicated by way of example in FIG. 6.

Specifically, FIG. 6 shows a schematic block diagram of a wireless communication system comprising a gNB connected via a satellite gateway to a moving NTN satellite for serving a cell in which two UEs are located. Thereby, in FIGS. 6, t1 and t2 denote the times at which the satellite is located in the corresponding positions. Obviously, the movement of the satellite causes a change of the round trip time or delay between the gNB and the corresponding UE.

Thus, starting from the above, there is a need for enhancements, improvements and/or modifications of one or more RAN procedures (e.g., from physical layer to higher layers) in order to be able to cope with large propagation delays in NTN.

It is noted that the information in the above section is only for enhancing the understanding of the background of the invention and therefore it may contain information that does not form conventional technology and is already known to a person of ordinary skill in the art.

### SUMMARY

An embodiment may have a user equipment of a wireless communication system, wherein the user equipment is configured to communicate with a base station of the wireless communication system via a satellite of the wireless communication system, wherein the user equipment is configured to receive, from the base station via the satellite or from another user equipment of the wireless communication system via a sidelink, a control information, the control information signaling parameters for parameterizing a non-linear function, the parameterized non-linear function describing a course of a round trip time or delay time between the satellite and one out of the base station or satellite gateway of the wireless communication system, or the satellite and a geographical reference point of the wireless communication system, or a first reference point and a second reference point, the first reference point having a fixed relation to the satellite and the second reference point having a fixed relation to one out of the base station, satellite gateway or user equipment, in dependence on a location of the satellite, wherein the user equipment is configured to time synchronize communications with the base station using the parameterized non-linear function.

Another embodiment may have a ase station of a wireless communication system, wherein the base station is configured to communicate with an user equipment of the wireless communication system via a satellite of the wireless communication system, wherein the base station is configured to transmit to the user equipment via the satellite a control information, the control information signaling parameters for parameterizing a non-linear function, the parameterized non-linear function describing a course of a round trip time or delay time between the satellite and one out of the base station or satellite gateway of the wireless communication system, or the satellite and a geographical reference point of the wireless communication system, or a first reference point and a second reference point, the first reference point having a fixed relation to the satellite and the second reference point having a fixed relation to one out of the base station, satellite gateway or user equipment, in dependence on a location of the satellite.

According to another embodiment, a method for operating a user equipment of a wireless communication system may have the steps of: receiving, from a base station of the wireless communication system via a satellite of the wireless communication system or from another user equipment of the wireless communication system via a sidelink, a control information, the control information signaling parameters for parameterizing a non-linear function, the parameterized non-linear function describing a course of a round trip time or delay time between the satellite and one out of the base station or satellite gateway of the wireless communication system, or the satellite and a geographical reference point of the wireless communication system, or a first reference point and a second reference point, the first reference point having a fixed relation to the satellite and the second reference point having a fixed relation to one out of the base station, satellite gateway or user equipment, in dependence on a location of the satellite, wherein time synchronizing communications with the base station using the parameterized non-linear function.

According to another embodiment, a method for operating a base station of a wireless communication system may have the steps of: transmitting to a user equipment of the wireless communication system via a satellite of the wireless communication system a control information, the control information signaling parameters for parameterizing a non-linear function, the parameterized non-linear function describing a course of a round trip time or delay time between the satellite and one out of the base station or satellite gateway of the wireless communication system, or the satellite and a geographical reference point of the wireless communication system, or a first reference point and a second reference point, the first reference point having a fixed relation to the satellite and the second reference point having a fixed relation to one out of the base station, satellite gateway or user equipment, in dependence on a location of the satellite.

Another embodiment may have a non-transitory digital storage medium having a computer program stored thereon to perform any of the inventive methods when said computer program is run by a computer.

An aspect of the specification provides user equipment of a wireless communication system, wherein the user equipment is configured to communicate with a base station of the wireless communication system via a satellite of the wireless communication system, wherein the user equipment is configured to receive, from the base station via the satellite or from another user equipment of the wireless communication system via a sidelink, a control information, the control information signaling parameters for parameterizing a non-linear function, the parameterized non-linear function describing a course of a round trip time or delay time between the satellite and one out of the base station or satellite gateway of the wireless communication system, or the satellite and a geographical reference point of the wireless communication system, or a first reference point and a second reference point, the first reference point having a fixed relation to the satellite and the second reference point having a fixed relation to one out of the base station, satellite gateway or user equipment, in dependence on a location of the satellite, wherein the user equipment is configured to time synchronize communications with the base station using the parameterized non-linear function.

An aspect of the specification provides user equipment, wherein the user equipment is configured to determine a round trip time or delay time for a certain time using the parameterized non-linear function, wherein the user equipment is configured to time synchronize communications with the base station at the certain time based on the determined round trip time or delay time.

An aspect of the specification provides user equipment, wherein the non non-linear function describes the course of the round trip time or delay time between the satellite and one out of the base station or satellite gateway, wherein the round trip time or delay time is a feeder link round trip time or feeder link delay time.

An aspect of the specification provides user equipment, wherein the non non-linear function describes the course of the round trip time or delay time between the satellite and the geographical reference point, wherein the round trip time or delay time is a common round trip time or common delay time.

An aspect of the specification provides user equipment, wherein the geographical reference point is located in one out of the base station, the satellite gateway, a feeder link between the satellite and one out of the satellite gateway or base station, a service link between the satellite and the user equipment or another user equipment of the wireless communication system or a certain point within a cell of the wireless communication system.

An aspect of the specification provides user equipment, wherein, in case the geographical reference point is located at the feeder link, the control information further includes an information describing a feeder link round trip time or delay time between the reference point and one out of the satellite gateway, base station or another reference point.

An aspect of the specification provides user equipment, wherein the user equipment is configured to time synchronize communications with the base station further using the feeder link round trip time or delay time.

An aspect of the specification provides user equipment, wherein, in case the geographical reference point is located at the service link, the control information further includes an information describing a feeder link round trip time or delay time between the satellite and one out of the satellite gateway, base station or another reference point.

An aspect of the specification provides user equipment, wherein the user equipment is configured to time synchronize communications with the base station further using the feeder link round trip time or delay time.

An aspect of the specification provides user equipment, wherein the parameterized non-linear function describes the course of the round trip time or delay time between the first reference point and the second reference point, wherein the control information further describes a portion of the round trip time or delay time between the base station and the satellite that is not described by the parameterized non-linear function.

An aspect of the specification provides user equipment, wherein the user equipment is configured to time synchronize communications with the base station further using the portion of the round trip time or delay time that is not described by the parameterized non-linear function.

An aspect of the specification provides user equipment, wherein the non-linear function is a power function or an exponential function or a polynomial function.

An aspect of the specification provides user equipment, wherein the user equipment is configured to determine a timing advance for a certain time based on the parameterized non-linear function.

An aspect of the specification provides user equipment, wherein the user equipment is configured to time synchronize communications with the base station at the certain time based on the determined timing advance.

An aspect of the specification provides user equipment, wherein the at least one parameter is signaled in units of for determining the timing advance, wherein the user equipment is configured to convert the at least one parameter via into at least one converted parameter in absolute value, wherein the user equipment is configured to use the at least one converted parameter for at least one other procedure.

An aspect of the specification provides user equipment, wherein at least one other procedure is at least one out of—a calculation of a round trip time or delay time between the user equipment and the base station.

An aspect of the specification provides user equipment, wherein control information signals absolute parameters for parametrizing the non-linear function, or wherein the control information signals an index of an entry out of a plurality of entries of a table, each entry of the table having stored at least one parameter associated with a corresponding satellite out of a plurality of satellites of the communication system.

An aspect of the specification provides user equipment, wherein the user equipment is configured, in case of a handover to another satellite or a switch to another feeder link, to receive a further signaling information prior to the handover to the other satellite or switch to the other feeder link, the further signaling information describing at least one further parameter for parameterizing the non-linear function, the further parameterized non-linear function describing a course of a round trip time or delay after the handover to the other satellite or the switch to the other feeder link.

An aspect of the specification provides user equipment, wherein the control information signaling the at least one parameter is transmitted via a system information block.

An aspect of the specification provides user equipment, wherein the user equipment is configured to relay or re-transmit the signaling information signaling the at least one parameter to at least one other user equipment of the wireless communication system via the sidelink.

An aspect of the specification provides user equipment, wherein the user equipment is configured to communicate with at least two satellites, wherein the user equipment is configured to receive, for each of the at least two satellites, a control information including a corresponding at least one parameter for parametrizing the non-linear function.

An aspect of the specification provides user equipment, wherein user equipment is configured to communicate with the base station via the satellite using carrier aggregation.

An aspect of the specification provides user equipment, wherein user equipment is configured to communicate with the base station via the satellite as supplementary uplink.

An aspect of the specification provides a base station of a wireless communication system, wherein the base station is configured to communicate with an user equipment of the wireless communication system via a satellite of the wireless communication system, wherein the base station is configured to transmit to the user equipment via the satellite a control information, the control information signaling parameters for parameterizing a non-linear function, the parameterized non-linear function describing a course of a round trip time or delay time between the satellite and one out of the base station or satellite gateway of the wireless communication system, or the satellite and a geographical reference point of the wireless communication system, or a first reference point and a second reference point, the first reference point having a fixed relation to the satellite and the second reference point having a fixed relation to one out of the base station, satellite gateway or user equipment, in dependence on a location of the satellite.

An aspect of the specification provides a base station, wherein the non non-linear function describes the course of the round trip time or delay time between the satellite and one out of the base station or satellite gateway, wherein the round trip time or delay time is a feeder link round trip time or feeder link delay time.

An aspect of the specification provides a base station, wherein the non non-linear function describes the course of the round trip time or delay time between the satellite and the geographical reference point, wherein the round trip time or delay time is a common round trip time or common delay time.

An aspect of the specification provides a base station, wherein the geographical reference point is located in one out of the base station, the satellite gateway, a feeder link between the satellite and one out of the satellite gateway or base station, a service link between the satellite and the user equipment or another user equipment of the wireless communication system or a certain point within a cell of the wireless communication system.

An aspect of the specification provides a base station, wherein, in case the geographical reference point is located at the feeder link, the control information further includes an information describing a feeder link round trip time or delay time between the reference point and one out of the satellite gateway or base station.

An aspect of the specification provides a base station, wherein, in case the geographical reference point is located at the service link, the control information further includes an information describing a feeder link round trip time or delay time between the satellite and one out of the satellite gateway or base station.

An aspect of the specification provides a base station, wherein the parameterized non-linear function describes the course of the round trip time or delay time between the first reference point and the second reference point, wherein the control information further describes a portion of the round trip time or delay time between the base station and the satellite that is not described by the parameterized non-linear function.

An aspect of the specification provides a base station, wherein the non-linear function is a power function or an exponential function or a polynomial function.

An aspect of the specification provides a base station, wherein control information signals absolute parameters for parametrizing the non-linear function, or wherein the control information signals an index of an entry of a table in which the corresponding parameters are stored.

An aspect of the specification provides a base station, wherein the control information signaling the at least one parameter is transmitted via a system information block.

An aspect of the specification provides method for operating a user equipment of a wireless communication system, the method including: receiving, from a base station of the wireless communication system via a satellite of the wireless communication system or from another user equipment of the wireless communication system via a sidelink, a control information, the control information signaling parameters for parameterizing a non-linear function, the parameterized non-linear function describing a course of a round trip time or delay time between the satellite and one out of the base station or satellite gateway of the wireless communication system, or the satellite and a geographical reference point of the wireless communication system, or a first reference point and a second reference point, the first reference point having a fixed relation to the satellite and the second reference point having a fixed relation to one out of the base station, satellite gateway or user equipment, in dependence on a location of the satellite, wherein time synchronizing communications with the base station using the parameterized non-linear function.

An aspect of the specification provides method for operating a base station of a wireless communication system, the method including: transmitting to a user equipment of the wireless communication system via a satellite of the wireless communication system a control information, the control information signaling parameters for parameterizing a non-linear function, the parameterized non-linear function describing a course of a round trip time or delay time between the satellite and one out of the base station or satellite gateway of the wireless communication system, or the satellite and a geographical reference point of the wireless communication system, or a first reference point and a second reference point, the first reference point having a fixed relation to the satellite and the second reference point having a fixed relation to one out of the base station, satellite gateway or user equipment, in dependence on a location of the satellite.

An aspect of the specification provides a non-transitory digital storage medium having a computer program stored thereon to perform the method for operating a user equipment of a wireless communication system, the method including: receiving, from a base station of the wireless communication system via a satellite of the wireless communication system or from another user equipment of the wireless communication system via a sidelink, a control information, the control information signaling parameters for parameterizing a non-linear function, the parameterized non-linear function describing a course of a round trip time or delay time between the satellite and one out of the base station or satellite gateway of the wireless communication system, or the satellite and a geographical reference point of the wireless communication system, or a first reference point and a second reference point, the first reference point having a fixed relation to the satellite and the second reference point having a fixed relation to one out of the base station, satellite gateway or user equipment, in dependence on a location of the satellite, wherein time synchronizing communications with the base station using the parameterized non-linear function, when said computer program is run by a computer.

An aspect of the specification provides a non-transitory digital storage medium having a computer program stored thereon to perform the method for operating a base station of a wireless communication system, the method including: transmitting to a user equipment of the wireless communication system via a satellite of the wireless communication system a control information, the control information signaling parameters for parameterizing a non-linear function, the parameterized non-linear function describing a course of a round trip time or delay time between the satellite and one out of the base station or satellite gateway of the wireless communication system, or the satellite and a geographical reference point of the wireless communication system, or a first reference point and a second reference point, the first reference point having a fixed relation to the satellite and the second reference point having a fixed relation to one out of the base station, satellite gateway or user equipment, in dependence on a location of the satellite, when said computer program is run by a computer.

### BRIEF DESCRIPTION OF THE DRAWINGS

Embodiments of the present invention will be detailed subsequently referring to the appended drawings, in which:

FIG. 1A shows a schematic representation of an example of a wireless communication system;

FIG. 1B shows a schematic representation of an example of a wireless communication system;

FIG. 2 is a schematic representation of an in-coverage scenario in which UEs directly communicating with each other are connected to a base station;

FIG. 3 is a schematic representation of an out-of-coverage scenario in which UEs directly communicating with each other receive no SL resource allocation configuration or assistance from a base station;

FIG. 4 is a schematic representation of a partial out-of-coverage scenario in which some of the UEs directly communicating with each other receive no SL resource allocation configuration or assistance from a base station;

FIG. 5 is a schematic representation of an in-coverage scenario in which UEs directly communicating with each other are connected to different base stations;

FIG. 6 shows a schematic block diagram of a wireless communication system comprising a gNB connected via a satellite gateway to a moving NTN satellite for serving a cell in which two UEs are located,

FIG. 7 shows in a diagram feeder link RTT as a function of time [4],

FIG. 8 shows a schematic representation of a wireless communication system comprising a transceiver, like a base station, and a plurality of communication devices, like UEs, communicating with transceiver via a satellite/non-terrestrial network,

FIG. 9 shows in a diagram a common delay as a function of time for different satellite altitudes,

FIG. 10 shows in a diagram a common delay as a function of time for different elevation angles,

FIG. 11 shows in a diagram the common delay (RTT of feeder link) plotted as a function of time for simulated RTT and estimated RTT via a power function, and

FIG. 12 illustrates an example of a computer system on which units or modules as well as the steps of the methods described in accordance with the inventive approach may execute.

### DETAILED DESCRIPTION OF THE INVENTION

Equal or equivalent elements or elements with equal or equivalent functionality are denoted in the following description by equal or equivalent reference numerals.

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

As already indicated above in the introduction, in 3GPP a new working item (WI), introducing Non-Terrestrial Networks (NTN) has been started. Within this WI the technical feasibility of various satellite systems (GEO, MEO, LEO, etc.) and High Altitude Platforms (HAPS) to be part of the network architecture of 3GPP Rel-17 will be studied.

One of the unique features of NTN is the large propagation delays experienced between user terminals (UE) and satellite systems, and as a consequence, the gNB. Typically, the propagation delays in terrestrial systems are less than 1 ms. However, in NTN, the propagation delays can potentially range from several milliseconds to hundreds of milliseconds depending on the altitudes of the spaceborne or airborne platforms and payload type in NTN.

In order to be able to cope with large propagation delays in NTN, there is a need for modifying one or more RAN procedures, e.g., from physical layer to higher layers [1], [2].

In the following, first, some examples of the procedures affected by large propagation delays in NTN are described. Second, relevant components of propagation delay in NTN, i.e., UE specific delay and UE common delay, are described.

Procedures Affected by NTN Propagation Delay

From RAN2 perspective, 4-step random access channel (RACH) and 2-step RACH procedures are affected. In particular, in RAN2 #112e [5] it was agreed to compensate the start of “ra-ResponseWindow” and “msgB-ResponseWindow” by user equipment (UE)-gNB round trip time (RTT). The agreement is provided below:

```
Agreement
If the start of the ra-ResponseWindow and
msgB-ResponseWindow is accurately
      compensated by UE-gNB RTT, ra-ResponseWindow and
      msgB-ResponseWindow are not extended in LEO/GEO.
```

In particular, ra-Response Window and msgB-Response Window are certain window of time in which UE expects to receive the message-2 (MSG2) from gNB, also called response message, to its preamble transmission in message-1 (MSG1) in 4-step and 2-step random access procedure, respectively.

Another procedure in RAN2 affected by UE-gNB delay (or RTT) is related to HARQ. Specifically, in RAN2 #112e & #113e [5]-[6] it is agreed that for NTN UEs with pre-compensation capability, drx-HARQ-RTT-TimerDL is offset by UE-specific RTT (UE-gNB delay). The agreement is provided below:

```
Agreement
For UE with pre-compensation capability (at least for the
HARQ-feedback enabled case. FFS
      for HARQ-feedback disabled, if supported),
      drx-HARQ-RTT-TimerDL is offset by
      UE-specific RTT (UE-gNB delay) in LEO/GEO.
      FFS if offset is applied to: 1) the
      start of the timers or 2) the timer value range (i.e.
      existing values within value range increased by offset)
```

From RAN1 perspective, one of the important procedures affected by large propagation delays in NTN is the timing advance procedure [2]. In timing advance procedure, after gNB estimates the RTT of UE, it sends the timing advance command for adjusting the uplink transmission timing of UE. Clearly, the value of timing advance command is related to UE-gNB RTT.

Another procedure dedicated to NTN is the procedure of feeder link switching [2]. In feeder link switching procedure, a satellite serving a UE in a cell is switched with a new satellite, and, as a result of this, the feeder link, i.e., communication link between the satellite and the gateway, is to be switched. Since the new satellite has a different geographical location compare to the old serving satellite, UE-gNB RTT is changed and the delay of the feeder link is to be signaled to the UE.

It can be observed from the above discussion that there are several procedures in NTN specifically need to be enhanced via UE-gNB RTT/delay.

In the following, the components of UE-gNB RTT/delay is described in further detail. UE-gNB RTT/Delay

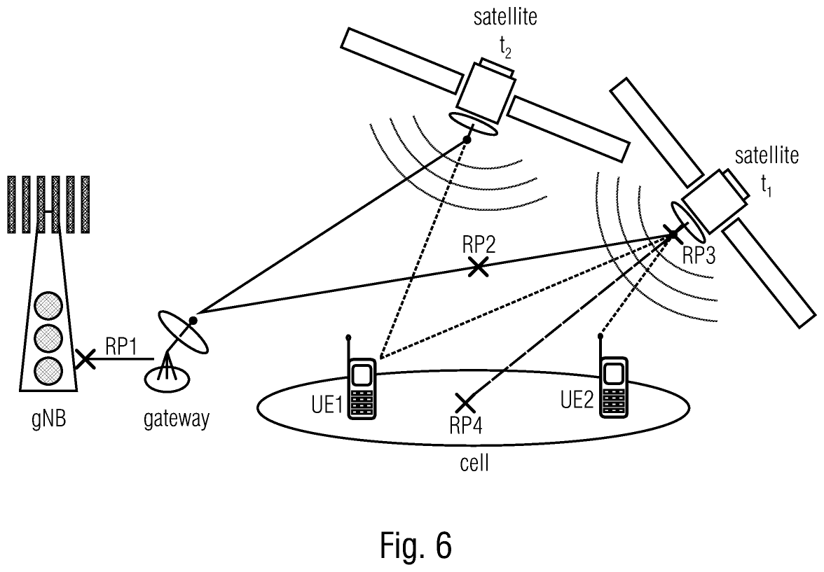

Generally, the end-to-end delay experienced by NTN UE can be split into two major parts namely, UE specific delay and UE common delay. Calculation of both, UE specific and UE common delay depends on the choice of the so-called reference point (RP). In particular, RP is defined as the point with respect to which the downlink and uplink frames are aligned after UE applies the TA command in RACH procedure. As a result of this, the value of TA is calculated with respect to RP. Typically, RP can be chosen to be at gNB, at feeder link, at the satellite, or at a point located at service link. It is decided in RAN1 that the choice of RP is arbitrary and it has to be under control of the network, and should at least include the RP at gNB, see FIG. 6. For instance, when the RP is chosen to be at satellite (RP3 in FIG. 6), when UE applies the TA command, the uplink and downlink frames are aligned at satellite and gNB has to deal with not aligned uplink and downlink frame timing and applies a post timing compensation based on RTT of feeder link.

On the other hand, the choice of RP at gNB (RP1 in FIG. 6) leads to frames timing in uplink and downlink that are aligned at gNB. Given the definition of the reference point above, the UE specific delay and UE common delay can be defined as described in the following.

The UE specific delay can be defined as the delay of the UE to the satellite. When RP is defined to be located at service link, the UE specific delay can be defined as the delay of the UE to the RP. In Rel17, NTN UE is assumed to be equipped with GNSS unit. As a result of this, GNSS equipped UE can estimate the distance to satellite together with the assistance of satellite ephemeris and calculates the UE-Satellite delay. If RP is chosen to be at service link, e.g. RP 4 in FIG. 6, then UE specific delay can be evaluated after subtracting the delay of Satellite to RP (Satellite-RP delay) from the UE-Satellite delay.

The UE common delay can be defined as the delay of satellite to the RP (Satellite-RP). Depending on the location of RP, UE common delay can be evaluated as follows:
It can capture the partial delay of the feeder link, when RP is chosen on the feeder link, e.g. RP 2 in FIG. 6.
It can be set to zero. This is the case when RP is chosen to be at satellite, e.g. RP 3 in FIG. 6.
It can capture the partial delay of the service link, when RP is chosen on the service link, e.g. RP 4 in FIG. 6.
It can capture the entire feeder link delay, i.e., gNB-gateway-Satellite delay, when the RP is chosen to be at gNB, e.g. RP 1 in FIG. 6.

In addition to the common delay, the feeder link delay can be defined as the delay of gNB to the RP. Note that for the case of RP at service link, feeder link delay can be defined as the delay of gNB to satellite. Some of the procedures reviewed in the beginning of this section may need the knowledge of end-to-end UE-gNB delay. Given the definition of the UE specific and UE common delay as above, unless for the case of RP at the gNB, for calculation of UE-gNB delay, signaling of both common delay and feeder link delay from network to UE may be needed.

Thereby it is noted that in the following description, it is referred to the feeder link delay and the common delay together, for conciseness of presentation and by way of example, as common delay. In other words, in the below description it is exemplarily assumed that RP is located at gNB. However, the procedures described in the following sections are also valid for other choices of RP as well.

Furthermore, due to the motion of satellite, the common delay is changed over time. For instance, in FIG. 6, the distance of the satellite to gateway is reduced from time t₁ to t₂ and leads to a change for the value of common delay. Thus, updated values of common delay need to be signaled to UE in order to update the outdated UE-gNB RTT.

Given the above discussion, embodiments described below rely on the signaling of common delay in NTN.

Commonly, different options are available for signaling of common delay.

The first option is network centric and gNB signals the absolute value of the common delay to the UE. However, due to the time-varying nature of the common delay, this approach demands for large signaling overhead, as frequent update of the value of the common delay is needed especially for LEO and VLEO satellites.

Another option, which is both network centric and UE centric, relies on autonomous calculation of the common delay at the UE side via a given function and signaling (or updating) the parameters of the function from gNB to the UE. This mechanism is proposed in [3], for TA and handover procedure. However, the details of the signaling is not discussed in [3].

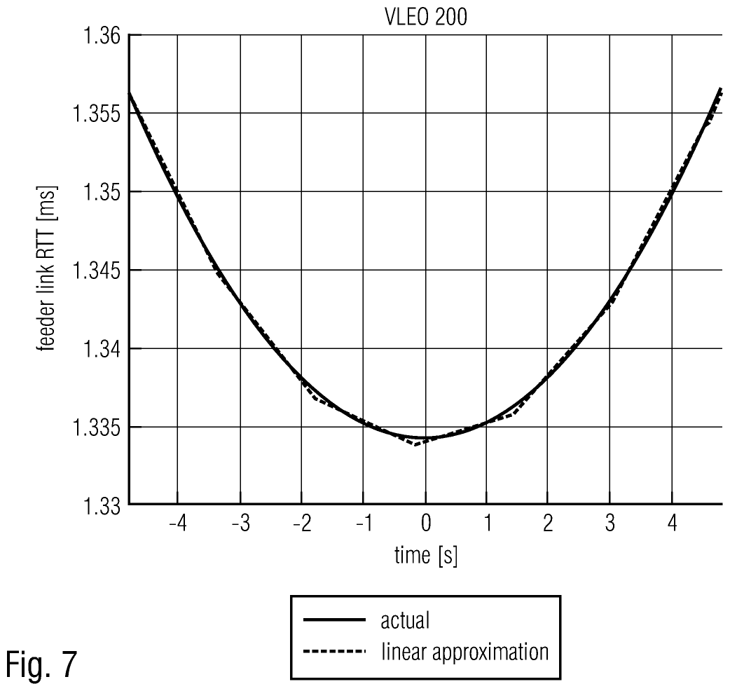

Furthermore, in [4], the “U” shape characteristic of the common delay (feeder link RTT) is approximated via piecewise linear function, see FIG. 7 below. Specifically, FIG. 7 shows in a diagram feeder link RTT as a function of time, [4]. Thereby, the ordinate denotes the feeder link RTT in ms, where the abscissa denotes the time in s.

Then, it is assumed that UE autonomously update the value of common delay, via a linear function, and gNB provide the UE with the parameters of the linear function, i.e., a constant term plus a drift value describing the slope of the linear function.

Clearly, the approach proposed above reduce the signaling overhead compare with the first option network centric introduced above. However, there is tradeoff between accuracy and signaling overhead. In order to have accurate approximation of the actual feeder link delay/RTT, the number of piecewise linear functions increases, which, in turn, increases the signaling overhead.

In the following, embodiments of the present invention are described, which reduce the signaling overhead even further and also improve the accuracy of the common delay estimation.

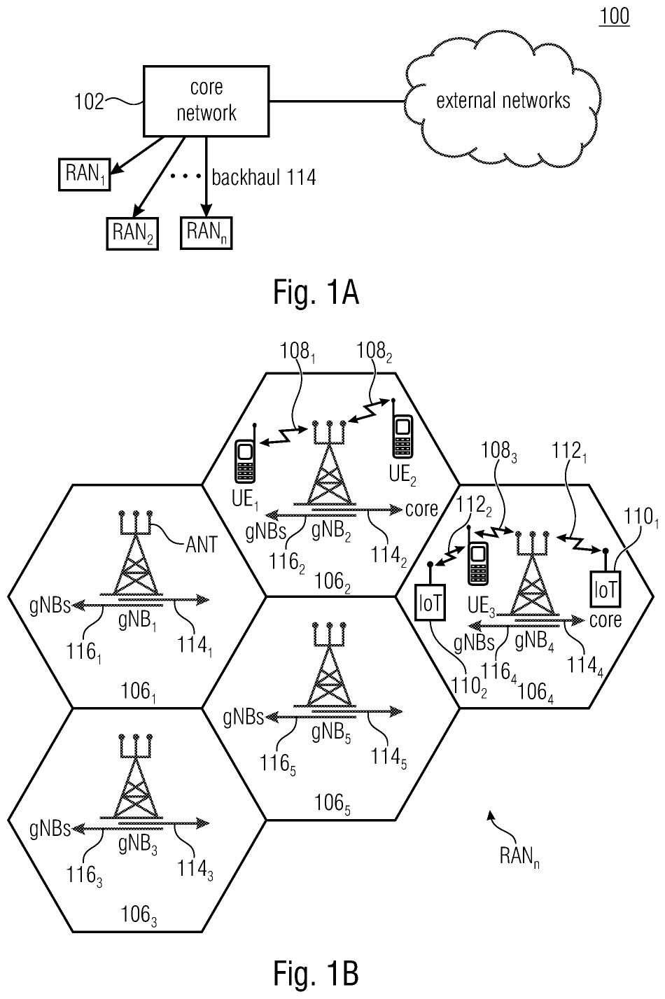

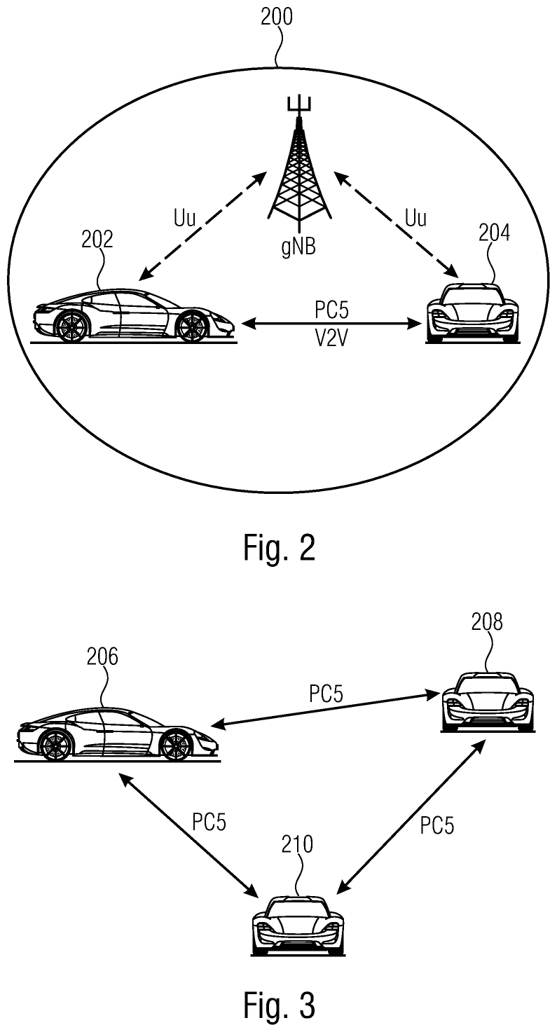

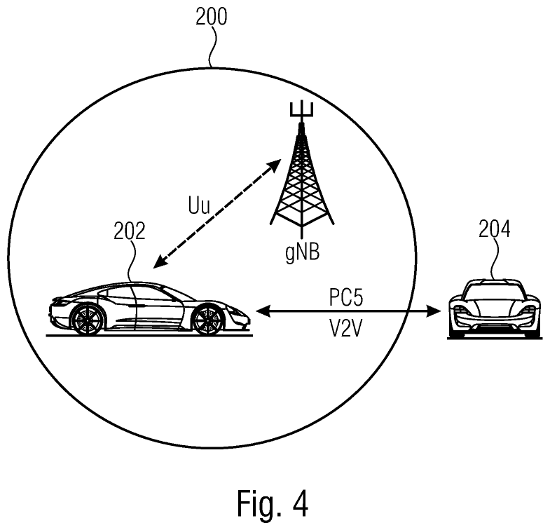

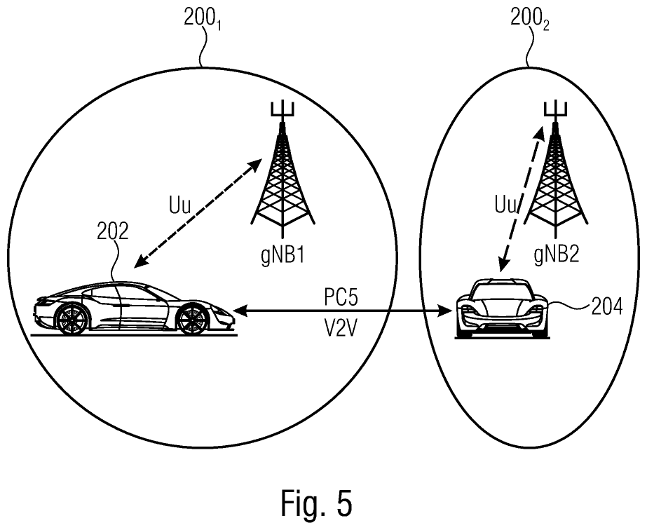

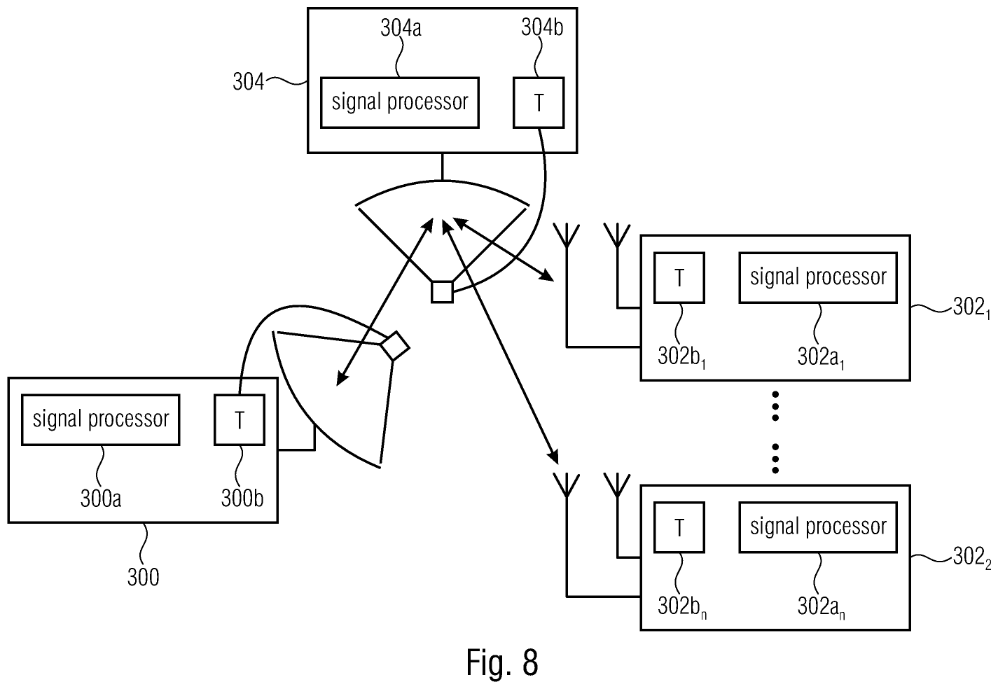

Thereby, embodiments of the present invention may be implemented in a wireless communication system or network as depicted in FIGS. 1 to 6 including a transceiver, like a base station, gNB, and a plurality of communication devices, like user equipment's, UEs, communicating with transceiver via a satellite/non-terrestrial network, NTN. FIG. 8 is a schematic representation of a wireless communication system comprising a transceiver 300, like a base station and a plurality of communication devices 302₁ to 302ₙ, like UEs, communicating with transceiver 300 via a satellite/non-terrestrial network 304. The transceiver 300 might include one or more antennas, a signal processor 300a and a transceiver unit 300b. The UEs 302₁ to 302ₙ might include one or more antennas, a signal processor 302a₁ to 302aₙ, and a transceiver unit 302b₁ to 302bₙ. The satellite 304 might include one or more antennas, a signal processor 304a and a transceiver unit 304b.The base station 200 and/or the one or more UEs 202 and/or the satellite 304 may operate in accordance with the inventive teachings described herein.

Embodiments provide a user equipment of a wireless communication system [e.g., 5G/new radio, NR], wherein the user equipment is configured to communicate with a base station [e.g., gNB] of the wireless communication system via a satellite of the wireless communication system, wherein the user equipment is configured to receive, from the base station via the satellite or from another user equipment of the wireless communication system via a sidelink, a control information, the control information signaling at least one parameter [e.g., one or more out of the parameters (a, b, c)] for parameterizing a non-linear function, the parameterized non-linear function [e.g., a parameterized version of the non-linear function] describing a course [e.g., variation] of a round trip time or delay time between
the satellite and one out of the base station or satellite gateway of the wireless communication system,
the satellite and a geographical reference point of the wireless communication system,
a first reference point and a second reference point, the first reference point having a fixed relation [e.g., distance] to the satellite and the second reference point having a fixed relation [e.g., distance] to one out of the base station, satellite gateway or user equipment, in dependence on a location of the satellite [e.g., with respect to the geographical reference point, the user equipment or a satellite gateway of the wireless communication system] [e.g., when the satellite is in range of the user equipment and/or satellite gateway].

In embodiments, the user equipment is configured to time synchronize [e.g., uplink and/or downlink frames for] communications [e.g., transmissions and/or receptions] with the base station using the parameterized non-linear function.

In embodiments, the user equipment is configured to determine a round trip time or delay time for a certain [e.g., current] time [e.g., slot] using the parameterized non-linear function, wherein the user equipment is configured to time synchronize communications with the base station at the certain time based on the determined round trip time or delay time.

In embodiments, the non non-linear function describes the course of the round trip time or delay time between the satellite and one out of the base station or satellite gateway, wherein the round trip time or delay time is a feeder link round trip time or feeder link delay time.

In embodiments, the non non-linear function describes the course of the round trip time or delay time between the satellite and the geographical reference point, wherein the round trip time or delay time is a common round trip time or common delay time.

In embodiments, the geographical reference point is located in one out of
the base station,
the satellite gateway,
a feeder link between the satellite and one out of the satellite gateway or base station,
a service link between the satellite and the user equipment or another user equipment of the wireless communication system or a certain point within a cell of the wireless communication system.

In embodiments, in case the geographical reference point is located at the feeder link, the control information further comprises an information describing a feeder link round trip time or delay time between the reference point and one out of the satellite gateway, base station or another reference point.

In embodiments, the user equipment is configured to time synchronize communications with the base station further using the feeder link round trip time or delay time.

In embodiments, in case the geographical reference point is located at the service link, the control information further comprises an information describing a feeder link round trip time or delay time between the satellite and one out of the satellite gateway, base station or another reference point.

In embodiments, the user equipment is configured to time synchronize communications with the base station further using the feeder link round trip time or delay time.

In embodiments, the parameterized non-linear function describes the course of the round trip time or delay time between the first reference point and the second reference point, wherein the control information further describes a [e.g., constant] portion of the round trip time or delay time between the base station and the satellite that is not described by the parameterized non-linear function [e.g., in case that the first reference point is not located at the satellite and/or the second reference point is not located at the base station].

In embodiments, the user equipment is configured to time synchronize communications with the base station further using the portion of the round trip time or delay time that is not described by the parameterized non-linear function.

In embodiments, the non-linear function is a power function or an exponential function or a polynomial function.

In embodiments, the non-linear function is

T_{RTT/delay}=a·f(t±t₀)^{b}+c

wherein T_{RTT/delay} describes the determined round trip time or delay time, wherein a, b, and c describe the parameters signaled by the control information, wherein t₀ describes the time [e.g., system frame number or slot number] at which the parameters a, b, and c are signaled to the user equipment, and wherein t describes a certain [e.g., current] time at which the determined round trip time or delay time is valid.

In embodiments, the user equipment is configured to determine a timing advance for a certain [e.g., current] time [e.g., slot] based on the parameterized non-linear function [e.g., to determine a part of the timing advance [e.g., the common part of the timing advance] based on the parameterized non-linear function].

In embodiments, the user equipment is configured to time synchronize communications with the base station at the certain time based on the determined timing advance.

In embodiments, the non-linear function is

N_{TA,common}=N_{TA,cons}+└(n_{CurrentSlot}±n₀)^{N}^{_{TA,power}}×N_{TA,scale}┘

wherein N_{TA,common} describes the common timing advance in units of T_{C}, wherein N_{TA,cons} can be obtained via a third parameter c of the signaled parameters in units of T_{C}, wherein N_{TA,power} can be obtained via a second parameter b of the signaled parameters, wherein N_{TA,scale} can be obtained via a first parameter a of the signaled parameters in units of T_{C} per unit of n₀^{b}, wherein n₀ describes the time [e.g., system frame number or slot number] at which the parameters a, b, and c are signaled to the user equipment, and wherein n_{CurrentSlot} describes a certain [e.g., current] time [e.g., system frame number or slot number] at which the determined timing advance is valid.

For example, the common timing advance is part of the timing advance, which further captures the effect of common/feeder link delay.

In embodiments, the non-linear function is

N_{TA,common}=N_{TA,cons}+└(n_{CurrentSlot}±n₀)×N_{TA,driftRate}^{UE autonomous}┘

N_{TA,driftRate}^{UE autonomous}=N_{TA,scale}×N_{TA,power}×(n₀)^{N}^{_{TA,power}}⁻1

wherein N_{TA,common} describes the common timing advance in units of T_{C}, wherein N_{TA,cons} can be obtained via a third parameter c of the signaled parameters in units of T_{C}, wherein N_{TA,power} can be obtained via a second parameter b of the signaled parameters, wherein N_{TA,scale} can be obtained via a first parameter a of the signaled parameters, wherein N_{TA,driftRate}^{UE autonomous} is the UE autonomously calculated drift rate in the units of T_{C} per unit of n₀, wherein n₀ describes the reference time [e.g., system frame number or slot number] implicitly or explicitly indicated to the UE, and wherein n_{CurrentSlot} describes a certain [e.g., current] time [e.g., system frame number or slot number] at which the determined timing advance is valid.

For example, the common timing advance is part of the timing advance, which further captures the effect of common/feeder link delay.

In embodiments, the at least one parameter is signaled in units of T_{C} for determining the timing advance, wherein the user equipment is configured to convert the at least one parameter via T_{C} into at least one converted parameter in absolute value, wherein the user equipment is configured to use the at least one converted parameter for at least one other procedure.

In embodiments, the at least one other procedure is at least one out of a calculation of a round trip time or delay time between the user equipment and the base station [e.g., for “drx-HARQ-RTT-TimerDL” or for a compensation of “ra-ResponseWindow” and “msgB-ResponseWindow].

In embodiments, the control information signals absolute parameters for parametrizing the non-linear function.

In embodiments, the control information signals an index of an entry [e.g., row] out of a plurality of entries of a table, each entry of the table having stored at least one parameter associated with a corresponding satellite out of a plurality of satellites of the communication system.

In embodiments, the user equipment is configured, in case of a handover to another satellite or a switch to another feeder link, to receive a further signaling information prior to the handover to the other satellite or switch to the other feeder link, the further signaling information describing at least one further parameter for parameterizing the non-linear function, the further parameterized non-linear function describing a course of a round trip time or delay after the handover to the other satellite or the switch to the other feeder link.

In embodiments, the control information signaling the at least one parameter is transmitted via a system information block.

In embodiments, the user equipment is configured to relay or re-transmit the signaling information signaling the at least one parameter to at least one other user equipment [e.g., unicast, multicast, groupcast or broadcast] of the wireless communication system via the sidelink.

In embodiments, the user equipment is configured to communicate with at least two satellites, wherein the user equipment is configured to receive, for each of the at least two satellites, a control information having a corresponding at least one parameter for parametrizing the non-linear function.

In embodiments, the user equipment is configured to communicate with the base station via the satellite using carrier aggregation.

In embodiments, the user equipment is configured to communicate with the base station via the satellite as supplementary uplink.

Further embodiments provide a base station [e.g., gNB] of a wireless communication system [e.g., 5G/new radio, NR], wherein the base station is configured to communicate with an user equipment of the wireless communication system via a satellite of the wireless communication system, wherein the base station is configured to transmit to the user equipment via the satellite a control information, the control information signaling at least one parameter [e.g., one or more out of the parameters (a, b, c)] for parameterizing a non-linear function, the parameterized non-linear function [e.g., a parameterized version of the non-linear function] describing a course [e.g., variation] of a round trip time or delay time between
the satellite and one out of the base station or satellite gateway of the wireless communication system,
the satellite and a geographical reference point of the wireless communication system,
a first reference point and a second reference point, the first reference point having a fixed relation [e.g., distance] to the satellite and the second reference point having a fixed relation [e.g., distance] to one out of the base station, satellite gateway or user equipment, in dependence on a location of the satellite [e.g., with respect to the geographical reference point, the user equipment or a satellite gateway of the wireless communication system] [e.g., when the satellite is in range of the user equipment and/or satellite gateway].

In embodiments, the non non-linear function describes the course of the round trip time or delay time between the satellite and one out of the base station or satellite gateway, wherein the round trip time or delay time is a feeder link round trip time or feeder link delay time.

In embodiments, the non non-linear function describes the course of the round trip time or delay time between the satellite and the geographical reference point, wherein the round trip time or delay time is a common round trip time or common delay time.

In embodiments, the geographical reference point is located in one out of
the base station,
the satellite gateway,
a feeder link between the satellite and one out of the satellite gateway or base station,
a service link between the satellite and the user equipment or another user equipment of the wireless communication system or a certain point within a cell of the wireless communication system.

In embodiments, in case the geographical reference point is located at the feeder link, the control information further comprises an information describing a feeder link round trip time or delay time between the reference point and one out of the satellite gateway or base station.

In embodiments, in case the geographical reference point is located at the service link, the control information further comprises an information describing a feeder link round trip time or delay time between the satellite and one out of the satellite gateway or base station.

In embodiments, the parameterized non-linear function describes the course of the round trip time or delay time between the first reference point and the second reference point, wherein the control information further describes a [e.g., constant] portion of the round trip time or delay time between the base station and the satellite that is not described by the parameterized non-linear function [e.g., in case that the first reference point is not located at the satellite and/or the second reference point is not located at the base station].

In embodiments, the non-linear function is a power function or an exponential function or a polynomial function.

In embodiments, the non-linear function is

T_{RTT/delay}=a·f(t±t₀)^{b}+c

wherein T_{RTT/delay} describes the determined round trip time or delay time, wherein a, b, and c describe the parameters signaled by the control information, wherein t₀ describes the time [e.g., system frame number or slot number] at which the parameters a, b, and c are signaled to the user equipment, and wherein t describes a certain [e.g., current] time at which the determined round trip time or delay time is valid.

In embodiments, the non-linear function is

N_{TA,common}=N_{TA,cons}+└(n_{CurrentSlot}±n₀)^{N}^{_{TA,power}}×N_{TA,scale┘}

wherein N_{TA,common} describes the common timing advance in units of T_{C}, wherein N_{TA,cons} can be obtained via a third parameter c of the signaled parameters in units of T_{C}, wherein N_{TA,power} can be obtained via a second parameter b of the signaled parameters, wherein N_{TA,scale} can be obtained via a first parameter a of the signaled parameters in units of T_{C} per unit of n₀^{b}, wherein n₀ describes the time [e.g., system frame number or slot number] at which the parameters a, b, and c are signaled to the user equipment, and wherein n_{CurrentSlot} describes a certain [e.g., current] time [e.g., system frame number or slot number] at which the determined timing advance is valid.

For example, the common timing advance is part of the timing advance, which further captures the effect of common/feeder link delay.

In embodiments, the non-linear function is

N_{TA,common}=N_{TA,cons}+└(n_{CurrentSlot}∓n₀)×N_{TA,driftRate}^{UE autonomous}┘

N_{TA,driftRate}^{UE autonomous}=N_{TA,scale}×N_{TA,power}×(n_{CurrentSlot})^{N}^{_{TA,power}}⁻¹

wherein N_{TA,common} describes the common timing advance in units of T_{C}, wherein N_{TA,cons} can be obtained via a third parameter c of the signaled parameters in units of T_{C}, wherein N_{TA,power} can be obtained via a second parameter b of the signaled parameters, wherein N_{TA,scale} can be obtained via a first parameter a of the signaled parameters, wherein N_{TA,driftRate}^{UE autonomous} is the UE autonomously calculated drift rate in the units of T_{C} per unit of n₀, wherein n₀ describes the reference time [e.g., system frame number or slot number] indicated to the UE, and wherein n_{CurrentSlot} describes a certain [e.g., current] time [e.g., system frame number or slot number] at which the determined timing advance is valid.

For example, the common timing advance is part of the timing advance, which further captures the effect of common/feeder link delay.

In embodiments, the control information signals absolute parameters for parametrizing the non-linear function.

In embodiments, the control information signals an index of an entry [e.g., row] of a table in which the corresponding parameters are stored [e.g., in the user equipment].

In embodiments, the control information signaling the at least one parameter is transmitted via a system information block.

Further embodiment provide a method for operating a user equipment of a wireless communication system [e.g., 5G/new radio, NR]. The method comprises a step of receiving,
from a base station of the wireless communication system via a satellite of the wireless communication system
or from another user equipment of the wireless communication system via a sidelink, a control information, the control information signaling at least one parameter [e.g., one or more out of the parameters (a, b, c)] for parameterizing a non-linear function, the parameterized non-linear function [e.g., a parameterized version of the non-linear function] describing a course [e.g., variation] of a round trip time or delay time between
the satellite and one out of the base station or satellite gateway of the wireless communication system,

the satellite and a geographical reference point of the wireless communication system,
a first reference point and a second reference point, the first reference point having a fixed relation [e.g., distance] to the satellite and the second reference point having a fixed relation [e.g., distance] to one out of the base station, satellite gateway or user equipment, in dependence on a location of the satellite [e.g., with respect to the geographical reference point, the user equipment or a satellite gateway of the wireless communication system] [e.g., when the satellite is in range of the user equipment and/or satellite gateway].

Further embodiments provide a method for operating a base station [e.g., gNB] of a wireless communication system [e.g., 5G/new radio, NR]. The method comprises a step of transmitting to a user equipment of the wireless communication system via a satellite of the wireless communication system a control information, the control information signaling at least one parameter [e.g., one or more out of the parameters (a, b, c)] for parameterizing a non-linear function, the parameterized non-linear function [e.g., a parameterized version of the non-linear function] describing a course [e.g., variation] of a round trip time or delay time between
the satellite and one out of the base station or satellite gateway of the wireless communication system,
the satellite and a geographical reference point of the wireless communication system,
a first reference point and a second reference point, the first reference point having a fixed relation [e.g., distance] to the satellite and the second reference point having a fixed relation [e.g., distance] to one out of the base station, satellite gateway or user equipment, in dependence on a location of the satellite [e.g., with respect to the geographical reference point, the user equipment or a satellite gateway of the wireless communication system] [e.g., when the satellite is in range of the user equipment and/or satellite gateway].

Subsequently, embodiments of the present invention are described in further detail.

As already indicated above, the end-to-end UE-gNB can be split into two parts: UE specific delay and UE common delay. In order to be able to understand the details of the signaling of the common delay, the UE common delay can be split into its constituent components. Furthermore, in the following, the terms RTT and delay are used interchangeably. In particular, given FIG. 6, the UE common delay/RTT can be written as follows:

RTT_{UE-Common}=RTT_{gNB-GTW}+RTT_{GTW-Sat}T_{Est.-Error}=RTT_{GTW-Sat}T_{Constant},

where
RTT_{gNB-GTW}: captures the RTT of the gNB to gateway. Due to the fix locations of both gNB and gateway, RTT_{gNB-GTW} is a constant.
T_{Est.-Error}: accounts for the estimation error of UE specific delay/RTT. The value of this term depends on the accuracy of GNSS unit and can be considered to be constant.
RTT_{GTW-Sat}: takes the delay/RTT of the gateway to the satellite into account. Due to the motion of the satellite, RTT_{GTW-Sat} is a time-varying term. However, since the motion of the satellite is quasi-deterministic, i.e., predictive satellite orbital motion plus minor random box motion of the satellite, RTT_{GTW-Sat} sat itself can be split into two terms. A deterministic and time-varying term plus a constant term accounting for estimation error of the RTT of gateway to satellite due to the box movement of the satellite.

Given the discussion above, RTT_{UE-Common} can be well approximated via the right-hand-side of the equation above, i.e., RTT_{UE-Common}=RTT_{GTW-Sat}+T_{Constant}, where T_{Constant} captures the effects of all constant terms and RTT_{GTW-Sat} is the only time-varying and deterministic term.

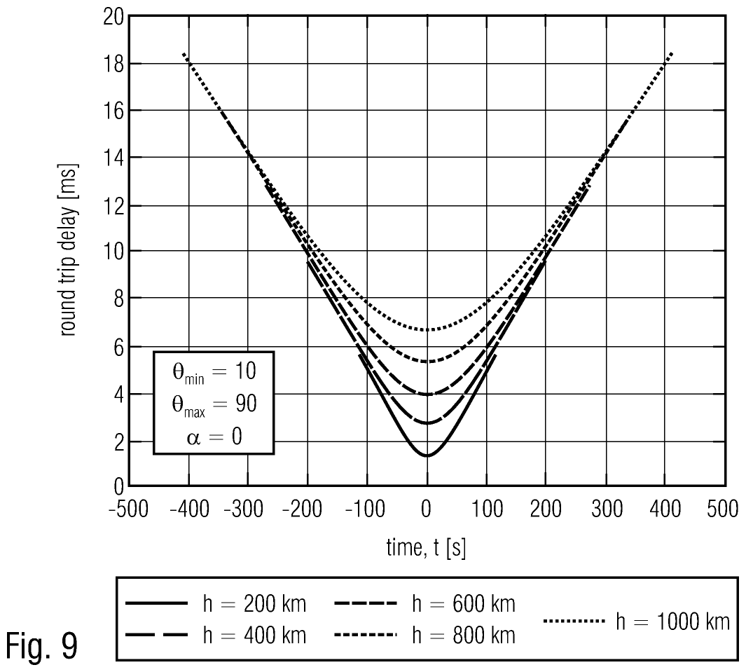

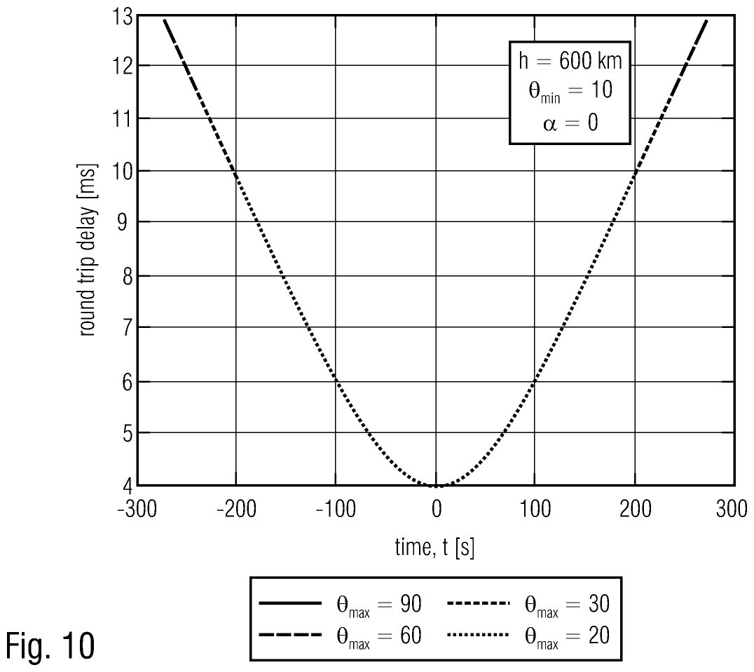

Before discussing the details of the signaling, it is worth to mention how RTT_{GTW-Sat} can be evaluated. In particular, RTT_{GTW-Sat} is a function of satellite altitude (h), minimum elevation angle (θₘᵢₙ), maximum elevation angle (θₘₐₓ), and satellite orbit inclination (α). FIGS. 9 and 10 show RTT_{GTW-Sat} for different system parameters.

In detail, in FIG. 9, the RTT from the gateway to the satellite, RTT_{GTW-Sat}, is plotted for different satellite altitudes. Thereby, the ordinate denote the RTT in ms, where the abscissa denotes the time in s. It can be observed that by increasing the altitude h, the visibility window of satellite at gateway increases. Furthermore, for all values of the altitude h, the “U” shape characteristic of RTT_{GTW-Sat} is preserved.

In FIG. 10, the RTT from the gateway to the satellite, RTT_{GTW-Sat}, is plotted for different maximum elevation angles. Thereby, the ordinate denotes the RTT in ms, where the abscissa denotes the time in s. Similar to the previous analysis, it can be observed that different values of maximum elevation angles θₘₐₓ changes the visibility window of the satellite. However, the characteristic of the RTT_{GTW-Sat} sat remains constant. Same observation with respect to behavior of RTT_{GTW-Sat} has been made for different range of values of θₘᵢₙ and also α.

One important conclusion from the above simulation results is the RTT_{GTW-Sat} shows a “U” shape characteristic. This particular characteristic can be employed for designing signaling mechanism with low signaling overhead.

Signaling Mechanism

In embodiments the RTT_{GTW-Sat} sat can be approximated as follows:

RTT_{UE-Common}=RTT_{GTW-Sat}+T_{Constant}=a f(t±t₀)^{b}+c,

where a, b, and c are some constant values that can be obtained offline given the satellite orbit parameters and/or trajectory. Function f(t) is an arbitrary function that can best capture the characteristic of RTT_{GTW-Sat}:
One example of function f(t) can be f(t)=t. This implies that RTT_{GTW-Sat} can be potentially modelled as a power function, i.e.,

RTT_{UE-common}=RTT_{GTW-Sat}+T_{Constant}=a(t±t₀)^{b}+c
Parameters a, b, and c can be obtained after parameter estimation.
Parameter t₀ can be implicitly obtained by UE or explicitly signaled to the UE. For example, t₀ can be obtained from system frame number (SFN) and “timestamp” slot number in which parameters a, b, and c are signaled to the UE.

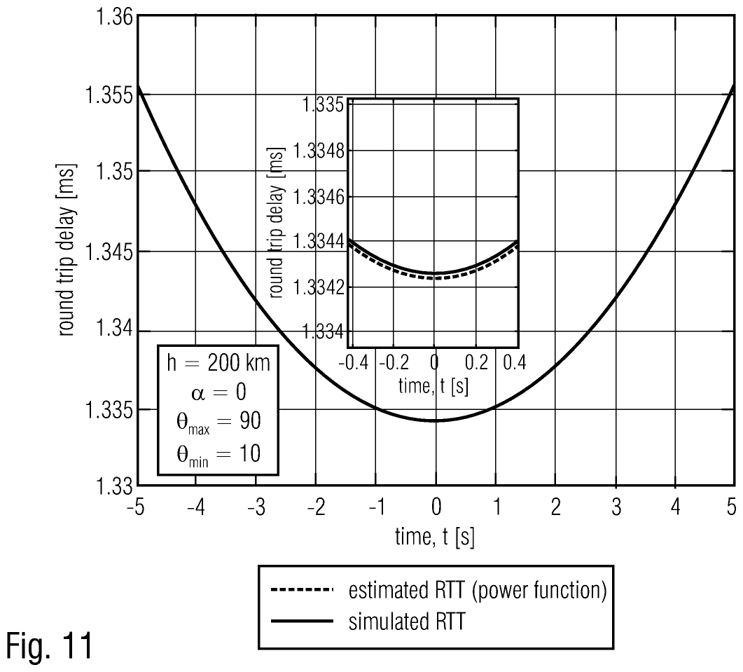

In order to assess the accuracy of the method proposed above, the same set of parameters are considered as in [4]. In FIG. 11, the common delay (RTT of feeder link) is plotted as a function of time for simulated RTT and estimated RTT via a power function. Thereby, the ordinate denotes the RTT in ms, where the abscissa denotes the time in s. The estimated parameters for this particular scenario are a=8.78×10⁻⁷, b=1.9855, c=0.0013. It can be observed that the actual RTT curve can be well approximated with the power function with very high accuracy, compared to the piecewise linear approximation method. Furthermore, the signaling overhead is substantially reduced, compared with the piecewise linear approximation, since the estimated parameters can be calculated offline once and be used for a longer time, without a need for an update.

In the following, first, the details of the common delay signaling for the TA procedure are discussed. Second, further discussion is provided for the details of the signaling that are relevant for other procedures introduced above.

Timing Advance Procedure

For the timing advance mechanism, the following expression can be employed for calculation of autonomous TA for NTN UE [8]

T_{TA}=(N_{TA}+N_{TA,UE-specific}+N_{TA,common}+N_{TA,offset})×T_{c},

where
T_{c}=1/(48000×4096),
N_{TA} and N_{TA,offset} are defined as in Release-16. In particular, the value of N_{TA,offset} is applied when transmitting PRACH preambles (before RRC connection) but N_{TA}=0. After RRC connection, N_{TA} is calculated via the TA command,
N_{TA,UE-specific} is UE self-estimated TA,
N_{TA,common} is network-controlled common TA, and may include any timing offset considered needed by the network.

In the expression above, N_{TA,UE-specific} is the parameter that is referred to as UE specific delay/RTT herein. Furthermore, N_{TA,common} is the parameter that is referred to as UE common delay/RTT, RTT_{UE-common}, herein and focused on for its signaling. For the TA procedure, RTT_{UE-Common}=N_{TA,common}×T_{c}, and N_{TA,common} has a unit of T_{c}. Thus, in embodiments, NTA,common can be determined as one out of the two following methods:

According to a first method, N_{TA,common} can be determined according to:

N_{TA,common}=N_{TA,cons}+└(n_{CurrentSlot}±n₀)^{N}_{TA,power}×N_{TA,scale}┘,

where
N_{TA,cons} can be obtained via estimated parameter c, in T_{c} unit,
N_{TA,power} can be obtained via estimated parameter b,
N_{TA,scale} can be obtained via estimated parameter a, in T_{c} unit per unit of n₀^{b},
n_{CurrentSlot} is the current uplink slot number,
n₀ is the “timestamp” slot number in which N_{TA,cons}, N_{TA,power}, N_{TA,driftRate} is signaled to the UE.

According to a second method, N_{TA,common} can be determined according to:

N_{TA,common}=N_{TA,cons}+└(n_{CurrenSlot}±n₀)×N_{TA,driftRate}^{UE autonomous}┘

N_{TA,driftRate}^{UE autonomous}=N_{TA,scale}×N_{TA,power}×(n₀)^{N}^{_{TA,power}}⁻¹

where
N_{TA,cons} can be obtained via estimated parameter c, in T_{c} unit,
N_{TA,power} can be obtained via estimated parameter b,
N_{TA,scale} can be obtained via estimated parameter a,
N_{TA,driftRate}^{UE autonomous} is (UE self estimated) UE autonomous calculated drift rate in T_{c} unit per slot,
n_{CurrentSlot} is the current uplink slot number,
n₀ is a reference slot number e.g., the “timestamp” slot number implicitly or explicitly signaled to the UE.

In NTN, and for Rel17, UE is to calculate the timing advance value, and correspondingly, the common delay, before starting the RACH procedure, i.e., before sending the preamble (MSG1) via PRACH. By doing this, UE obtain time synchronization in its corresponding UL transmissions. As a result of this, the estimated parameters a, b, and c (N_{TA,cons}, N_{TA,power}, N_{TA,scale} in case of TA procedure) has to signal to UE before PRACH start.

In embodiments, the estimated parameters a, b, and c (N_{TA,cons}, N_{TA,power}, N_{TA,scale} in case of TA procedure) can be broadcasted via system information block (SIB), e.g. SIB1 or any SIB dedicated to NTN.

Other Procedures

In the case of other procedures introduced in the beginning of this document, if the estimated parameters are signaled first for the TA procedure (in T_{c} unit), UE can convert the estimated parameters into absolute values via T_{c}. Then, UE can employ the absolute values of estimated parameters for calculation of UE common delay, and consequently end-to-end UE-gNB delay, which is needed in other procedures.

Other Signaling Aspects

In the following, other relevant aspects of the common delay signaling are discussed.

According to a first aspect, the signaling method explained above is also valid for multiple UEs in a cell. Further, the signaling method explained above is also valid for one UE communicating with multiple satellites, and/or communicating via carrier aggregation, and/or communicating via supplementary uplink.

Thereby, for UEs in proximity, the signaling may also be distributed using the sidelink as direct communication link between UEs.

Further, in case of sidelink, either (1) broadcast (distributing the relevant information to all UEs in proximity) or (2) groupcast/multicast (distributing with a configured or spontaneous group of UEs, where one UE could serve as a group head responsible to distribute the satellite specific information), or (3) unicast (individual link to one nearby UE) may apply.

Further, in case of Uu, also multicast (group of UEs using satellite(s) for communication) may be used to distribute the satellite specific information (e.g. corrections of drifts).

According to a second aspect, since the satellite orbital motion is predictive, for a UE in a cell with fixed geographical location, and being served with multiple satellites, the estimated parameters aᵢ, bᵢ, and cᵢ for the ith satellite, i={1, 2, 3, . . . M}, where M is the total number of satellites, can be stored as ith row of a look-up table.

Thereby, the look-up table can be configured to the UE via RRC signaling.

Depending on the serving satellite, at a certain time, gNB can signal the corresponding index value of corresponding row of a look-up table.

According to a third aspect, all the discussions above are also valid for the case where instead of index signaling, the absolute value of estimated parameters are signaled to the UE.

According to a sixth aspect, for the hand-over procedure, the estimated parameters a_{new}^{sat}, b_{new}^{sat}, and c_{new}^{sat} of the new satellite, that UE is going to hand-over to, is signaled via the current serving satellite before the hand-over procedure, or the corresponding index of a_{new}^{sat}, b_{new}^{sat}, and c_{new}^{sat}, is sent to the UE, if a_{new}^{sat}, b_{new}^{sat}, and c_{new}^{sat} are stored in a look-up table.

According to a seventh aspect, in the event of feeder link switch, the estimated parameters a_{new}^{feeder, b}_{new}^{feeder}, and c_{new}^{feeder}, associated with the common delay experienced via the new/switched gateway in the feeder link, or its corresponding index in the look-up table are signaled to the UE before the feeder link switch occurs.

According to an eights aspect, all the methods mentioned above are also valid if UE is configured with multiple look-up tables, where each look-up table is configured for different procedures, and each row of a look-up table corresponds to a potential serving satellite.

Thereby, a signaling mechanism in which DCI information activates/de-activates one table out of a set of RRC configured look-up tables.

According to a ninth aspect, periodicity/frequency of report being exchanged: this may depend on any possible drift of the satellite or the moving speed and/or direction of the UE.

Further Embodiments

Embodiments described herein may be implemented or used for several procedures (see below) in RAN1 and RAN2, which need enhancement for NTN depending on the round trip time (RTT) of UE and gNB.

As indicated above, UE-gNB RTT in NTN can be split into two parts namely, common RTT (or common delay) and UE specific RTT (or UE specific delay).

Thereby, the UE specific delay is the delay of UE to satellite, which can be acquired, for example, via UE GNSS unit and satellite ephemeris.

The common delay is common to all UEs. The common delay captures the delay of gNB-Gateway-Satellite (feeder-link).

Embodiments described herein may be implemented or used for procedures affected by UE-gNB RTT, such as one or more of the following:
RAN2: 4-step RACH, 2-step RACH procedures,
RAN2: drx-HARQ-RTT timers,
RAN1: Timing advance procedure,
RAN1: Feeder link switch procedure.

As indicated above, the common delay is under control of the network and must be signal to all UEs in the cell. Due to the motion of satellite, common delay is changing with time and needs frequent signaling from network side to UE to update the value of common delay. Embodiment provide a signaling mechanism of common delay with low signaling overhead.

In accordance with embodiments, the common delay (and Feeder link RTT), which has “U” shape characteristics, is approximated with power functions, i.e., at^{b+c} (see FIG. 11). Embodiments achieve very accurate approximation of RTT function. Signaling overhead can be substantially reduced, as only three parameters need to be signaled (a, b, c).

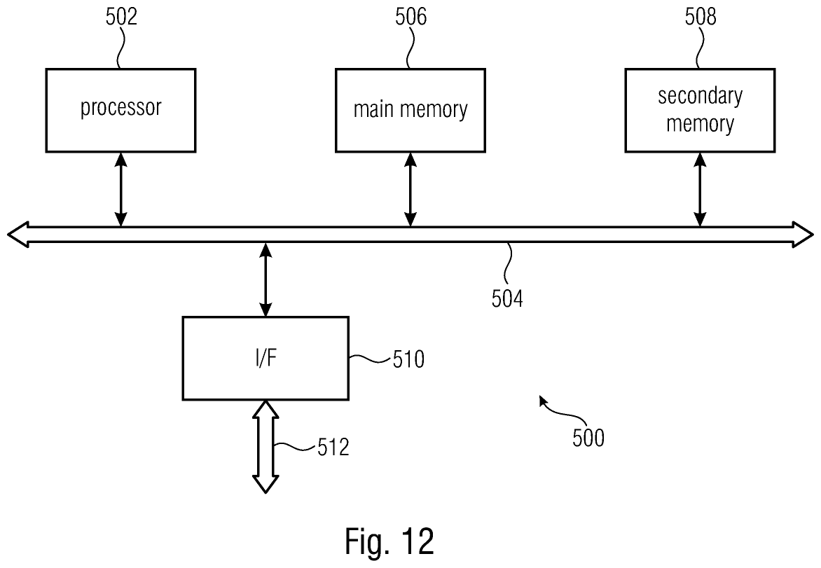

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 12 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the form electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein.

In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] 3GPP TR 38.811, “Study on New Radio (NR) to support non terrestrial networks (Release 15),” 3rd Generation Partnership Project; Technical Specification Group Radio Access Network, Version 15.1.0, June 2019.

[2] 3GPP TR 38.821 v16.0.0 (2019-12): 3rd Generation Partnership Project; Technical Specification Group Radio Access Network; Solutions for NR to support non-terrestrial networks (NTN) (Release 16).

[3] US 2020/0196263 A1

[4] R1-2100927, “On UL time and frequency synchronization enhancements for NTN”, Ericsson, January 2021.

[5] R2-2010702, “Report from Break-out session on R16 eMIMO, CLI, PRN, RACS and R17 NTN and REDCAP”, November 2020.

[6] R2-2101952, “Report from Break-out session on R16 eMIMO, CLI, PRN, RACS and R17 NTN and REDCAP”, January 2021.

[7] 3GPP TSG RAN WG1 Meeting #104-e, “RAN1 Chairman's Notes”, January 2021.

[8] 3GPP TSG RAN WG1 Meeting #104-e, “RANI Chairman's Notes 8.4 v005”, January 2021.

### ABBREVIATIONS

3GPP third generation partnership project

AIM assistance information message

AL alert limit

AMF access and mobility management function

ARAIM advanced receiver autonomous integrity monitoring

BS base station

BWP bandwidth part

CA carrier aggregation

CC component carrier

CBG code block group

CBR channel busy ratio

D2D device-to-device

DAI downlink assignment index

DCI downlink control information

DL downlink

FFT fast Fourier transform

GMLC gateway mobile location center

gNB evolved node B (NR base station)/next generation node B base station

GNSS global navigation satellite system

GTW gateway

HAL horizontal alert limit

HARQ hybrid automatic repeat request

IoT internet of things

LCS location services

LEO low earth orbiter

LMF location management function

LPP LTE positioning protocol

LTE long-term evolution

MAC medium access control

MCR minimum communication range

MCS modulation and coding scheme

MIB master information block

MO-LR mobile originated location request

MT-LR mobile terminated location request

NB node B

NI-LR network induced location request

NR new radio

NRPPa NR positioning protocol-annex

NTN non-terrestrial network

NW network

OFDM orthogonal frequency-division multiplexing

OFDMA orthogonal frequency-division multiple access

PBCH physical broadcast channel

PC5 interface using the sidelink channel for D2D communication

PDCCH physical downlink control channel

PDSCH physical downlink shared channel

PL protection level

PLMN public land mobile network

PPP point-to-point protocol

PPP precise point positioning

PRACH physical random access channel

PRB physical resource block

PRS public regulated services (Galileo)

PDCCH physical sidelink control channel

PSSCH physical sidelink shared channel

PUCCH physical uplink control channel

PUSCH physical uplink shared channel

PVT position and/or velocity and/or time

PVT position, velocity and time

RAIM receiver autonomous integrity monitoring

RAN radio access networks

RAT radio access technology

RB resource block

RNTI radio network temporary identifier

RP reference point

RRC radio resource control

RS reference symbols/signal

RTK real time kinematics

RTT round trip time

Sat satellite

SBAS space-based augmentation systems

SBI service based interface

SCI sidelink control information

SI system information

SIB sidelink information block

SL sidelink

SSR state space representation

sTTI short transmission time interval

TA timing advance

TDD time division duplex

TDOA time difference of arrival

TIR target integrity risk

TRP transmission reception point

TTA time-to-alert

TTI transmission time interval

UAV unmanned aerial vehicle

UCI uplink control information

UE user equipment

UL uplink

UMTS universal mobile telecommunication system

V2x vehicle-to-everything

V2V vehicle-to-vehicle

V2I vehicle-to-infrastructure

V2P vehicle-to-pedestrian

V2N vehicle-to-network

VLEO very low earth orbiter

P-UE pedestrian UE

V-UE vulnerable UE

1. User equipment of a wireless communication system,
wherein the user equipment is configured to communicate with a base station of the wireless communication system via a satellite of the wireless communication system,
wherein the user equipment is configured to receive, from the base station via the satellite or from another user equipment of the wireless communication system via a sidelink, a control information, the control information signaling parameters for parameterizing a non-linear function, the parameterized non-linear function describing a course of a round trip time or delay time between
the satellite and one out of the base station or satellite gateway of the wireless communication system, or
the satellite and a geographical reference point of the wireless communication system, or
a first reference point and a second reference point, the first reference point having a fixed relation to the satellite and the second reference point having a fixed relation to one out of the base station, satellite gateway or user equipment,
in dependence on a location of the satellite,
wherein the user equipment is configured to time synchronize communications with the base station using the parameterized non-linear function.

2. User equipment according to claim 1,
wherein the user equipment is configured to determine a round trip time or delay time for a certain time using the parameterized non-linear function,
wherein the user equipment is configured to time synchronize communications with the base station at the certain time based on the determined round trip time or delay time.

3. User equipment according to claim 1,
wherein the non non-linear function describes the course of the round trip time or delay time between the satellite and one out of the base station or satellite gateway,
wherein the round trip time or delay time is a feeder link round trip time or feeder link delay time,
or wherein the non non-linear function describes the course of the round trip time or delay time between the satellite and the geographical reference point, wherein the round trip time or delay time is a common round trip time or common delay time,
or wherein the parameterized non-linear function describes the course of the round trip time or delay time between the first reference point and the second reference point, wherein the control information further describes a portion of the round trip time or delay time between the base station and the satellite that is not described by the parameterized non-linear function.

4.-10. (canceled)

11. User equipment according to claim 3,
wherein the user equipment is configured to time synchronize communications with the base station further using the portion of the round trip time or delay time that is not described by the parameterized non-linear function.

12. User equipment according to claim 1,
wherein the non-linear function is a power function or an exponential function or a polynomial function.

13. User equipment according to claim 1, wherein the non-linear function is
T_{RTT/delay}=a·f(t±t₀)^{b}+c
wherein T_{RTT/delay} describes the determined round trip time or delay time, wherein a, b, and c describe the parameters signaled by the control information, wherein to describes the time at which the parameters a, b, and c are signaled to the user equipment, and wherein t describes a certain time at which the determined round trip time or delay time is valid.

14. User equipment according to claim 1,
wherein the user equipment is configured to determine a timing advance for a certain time based on the parameterized non-linear function.

15. (canceled)

16. User equipment according to claim 1,
wherein the non-linear function is
N_{TA,common}=N_{TA,cons}+└(n_{CurrentSlot}±n₀)^{N}^{_{TA,power}}×N_{TA,scale┘}
wherein N_{TA,common} describes the common timing advance in units of T_{c}, wherein N_{TA,cons} can be acquired via a third parameter c of the signaled parameters in units of T_{c}, wherein N_{TA,power} can be acquired via a second parameter b of the signaled parameters, wherein N_{TA,scale} can be acquired via a first parameter a of the signaled parameters in units of T_{c} per unit of n₀, wherein no describes the time at which the parameters a, b, and c are signaled to the user equipment, and wherein n_{CurrentSlot} describes a certain time at which the determined timing advance is valid.

17. User equipment according to claim 1,
wherein the non-linear function is
N_{TA,common}=N_{TA,cons}+└(n_{CurrentSlot}±n₀)×N_{TA,driftRate}^{UE autonomous}┘
N_{TA,driftRate}^{UE autonomous}=N_{TA,scale}×N_{TA,power}×(n₀)^{N}^{_{TA,power}}⁻¹
wherein N_{TA,common} describes the common timing advance in units of T_{C}, wherein N_{TA,cons} can be acquired via a third parameter c of the signaled parameters in units of T_{C}, wherein N_{TA,power} can be acquired via a second parameter b of the signaled parameters, wherein N_{TA,scale} can be acquired via a first parameter a of the signaled parameters, wherein N_{TA,driftRate}^{UE autonomous} is the UE autonomously calculated drift rate in the units of T_{C} per unit of n₀, wherein n₀ describes the reference time implicitly or explicitly indicated to the UE, and wherein n_{CurrentSlot} describes a certain time at which the determined timing advance is valid.

18.-19. (canceled)

20. User equipment according to claim 1,
wherein control information signals absolute parameters for parametrizing the non-linear function,
or wherein the control information signals an index of an entry out of a plurality of entries of a table, each entry of the table having stored at least one parameter associated with a corresponding satellite out of a plurality of satellites of the communication system,
or wherein the control information signaling the at least one parameter is transmitted via a system information block,

21. User equipment according to claim 1,
wherein the user equipment is configured, in case of a handover to another satellite or a switch to another feeder link, to receive a further signaling information prior to the handover to the other satellite or switch to the other feeder link, the further signaling information describing at least one further parameter for parameterizing the non-linear function, the further parameterized non-linear function describing a course of a round trip time or delay after the handover to the other satellite or the switch to the other feeder link,
or wherein the user equipment is configured to relay or re-transmit the signaling information signaling the at least one parameter to at least one other user equipment of the wireless communication system via the sidelink,
or wherein the user equipment is configured to communicate with at least two satellites, wherein the user equipment is configured to receive, for each of the at least two satellites, a control information having a corresponding at least one parameter for parametrizing the non-linear function,
or wherein user equipment is configured to communicate with the base station via the satellite using carrier aggregation,
or wherein user equipment is configured to communicate with the base station via the satellite as supplementary uplink.

22.-26. (canceled)

27. Base station of a wireless communication system,
wherein the base station is configured to communicate with an user equipment of the wireless communication system via a satellite of the wireless communication system,
wherein the base station is configured to transmit to the user equipment via the satellite a control information, the control information signaling parameters for parameterizing a non-linear function, the parameterized non-linear function describing a course of a round trip time or delay time between
the satellite and one out of the base station or satellite gateway of the wireless communication system, or
the satellite and a geographical reference point of the wireless communication system, or
a first reference point and a second reference point, the first reference point having a fixed relation to the satellite and the second reference point having a fixed relation to one out of the base station, satellite gateway or user equipment,
in dependence on a location of the satellite.

28. Base station according to claim 27,
wherein the non non-linear function describes the course of the round trip time or delay time between the satellite and one out of the base station or satellite gateway,
wherein the round trip time or delay time is a feeder link round trip time or feeder link delay time,
or wherein the non non-linear function describes the course of the round trip time or delay time between the satellite and the geographical reference point, wherein the round trip time or delay time is a common round trip time of common delay time,
or wherein the parameterized non-linear function describes the course of the round trip time or delay time between the first reference point and the second reference point, wherein the control information further describes a portion of the round trip time or delay time between the base station and the satellite that is not described by the parameterized non-linear function.

29.-33. (canceled)

34. Base station according to claim 27,
wherein the non-linear function is a power function or an exponential function or a polynomial function.

35. Base station according to claims 27,
wherein the non-linear function is
T_{RTT/delay}=a·f(t+t₀)^{b}+c
wherein T_{RTT/delay} describes the determined round trip time or delay time, wherein a, b, and c describe the parameters signaled by the control information, wherein to describes the time at which the parameters a, b, and c are signaled to the user equipment, and wherein t describes a certain time at which the determined round trip time or delay time is valid.

36. Base station according to claims 27,
wherein the non-linear function is
N_{TA,common}=N_{TA,cons}+└(n_{CurrentSlot}±n₀)^{N}^{_{TA,power}}×N_{TA,scale}┘
wherein N_{TA,common} describes the common timing advance in units of T_{c}, wherein N_{TA,cons} can be acquired via a third parameter c of the signaled parameters in units of T_{c}, wherein N_{TA,power} can be acquired via a second parameter b of the signaled parameters, wherein N_{TA,scale} can be acquired via a first parameter a of the signaled parameters in units of T_{c} per unit of n₀^{b}, wherein no describes the time at which the parameters a, b, and c are signaled to the user equipment, and wherein n_{CurrentSlot} describes a certain time at which the determined timing advance is valid.

37. Base station according to claims 27,
wherein the non-linear function is
N_{TA,common}=N_{TA,cons}+└(n_{CurrenSlot}∓n₀)×N_{TA,driftRate}^{UE autonomous}┘
N_{TA,driftRate}^{UE autonomous}=N_{TA,scale}×N_{TA,power}×(n_{CurrentSlot})^{N}^{_{TA,power}}⁻¹
wherein N_{TA,common} describes the common timing advance in units of T_{c}, wherein N_{TA,cons} can be acquired via a third parameter c of the signaled parameters in units of T_{c}, wherein N_{TA,power} can be acquired via a second parameter b of the signaled parameters, wherein N_{TA,scale} can be acquired via a first parameter a of the signaled parameters, wherein N_{TA,driftRate}^{UE autonomous} is the UE autonomously calculated drift rate in the units of T_{c} per unit of n₀, wherein n₀ describes the reference time indicated to the UE, and wherein n_{CurrentSlot} describes a certain time at which the determined timing advance is valid.

38. Base station according to claim 27,
wherein control information signals absolute parameters for parametrizing the non-linear function,
or wherein the control information signals an index of an entry of a table in which the corresponding parameters are stored,
or wherein the control information signaling the at least one parameter is transmitted via a system information block.

39. (canceled)

40. Method for operating a user equipment of a wireless communication system, the method comprising:
receiving,
from a base station of the wireless communication system via a satellite of the wireless communication system
or from another user equipment of the wireless communication system via a sidelink,
a control information, the control information signaling parameters for parameterizing a non-linear function, the parameterized non-linear function describing a course of a round trip time or delay time between
the satellite and one out of the base station or satellite gateway of the wireless communication system, or
the satellite and a geographical reference point of the wireless communication system, or
a first reference point and a second reference point, the first reference point having a fixed relation to the satellite and the second reference point having a fixed relation to one out of the base station, satellite gateway or user equipment,
in dependence on a location of the satellite,
wherein time synchronizing communications with the base station using the parameterized non-linear function.

41. Method for operating a base station of a wireless communication system, the method comprising:
transmitting to a user equipment of the wireless communication system via a satellite of the wireless communication system a control information, the control information signaling parameters for parameterizing a non-linear function, the parameterized non-linear function describing a course of a round trip time or delay time between
the satellite and one out of the base station or satellite gateway of the wireless communication system, or
the satellite and a geographical reference point of the wireless communication system, or
a first reference point and a second reference point, the first reference point having a fixed relation to the satellite and the second reference point having a fixed relation to one out of the base station, satellite gateway or user equipment,
in dependence on a location of the satellite.

42. A non-transitory digital storage medium having a computer program stored thereon to perform the method for operating a user equipment of a wireless communication system, the method comprising:
receiving,
from a base station of the wireless communication system via a satellite of the wireless communication system
or from another user equipment of the wireless communication system via a sidelink,
a control information, the control information signaling parameters for parameterizing a non-linear function, the parameterized non-linear function describing a course of a round trip time or delay time between
the satellite and one out of the base station or satellite gateway of the wireless communication system, or
the satellite and a geographical reference point of the wireless communication system, or
a first reference point and a second reference point, the first reference point having a fixed relation to the satellite and the second reference point having a fixed relation to one out of the base station, satellite gateway or user equipment,
in dependence on a location of the satellite,
wherein time synchronizing communications with the base station using the parameterized non-linear function,
when said computer program is run by a computer.

43. A non-transitory digital storage medium having a computer program stored thereon to perform the method for operating a base station of a wireless communication system, the method comprising:
transmitting to a user equipment of the wireless communication system via a satellite of the wireless communication system a control information, the control information signaling parameters for parameterizing a non-linear function, the parameterized non-linear function describing a course of a round trip time or delay time between
the satellite and one out of the base station or satellite gateway of the wireless communication system, or
the satellite and a geographical reference point of the wireless communication system, or
a first reference point and a second reference point, the first reference point having a fixed relation to the satellite and the second reference point having a fixed relation to one out of the base station, satellite gateway or user equipment,
in dependence on a location of the satellite,
when said computer program is run by a computer.
